(19) United States
(12) Patent Application Publication
(10) Pub. No.: US 2016/0274663 A1
(43) Pub. Date: Sep. 22, 2016

(54) CONTROL APPARATUS

(71) Applicant: Panasonic Intellectual Property Management Co., Ltd., Osaka (JP)

(72) Inventors: TOSHIYUKI AOYAMA, Osaka (JP); SATORU TANAHASHI, Osaka (JP); HIROYUKI KADO, Osaka (JP); NAOKI KOSUGI, Kyoto (JP); TAKASHI KITADA, Osaka (JP)

(21) Appl. No.: 15/063,668

(22) Filed: Mar. 8, 2016

(30) Foreign Application Priority Data
Mar. 19, 2015 (JP) 2015-055654
Dec. 15, 2015 (JP) 2015-244055

(51) Int. Cl. G06F 3/01; G06F 3/041; G09B 5/02; G06F 3/044

(52) U.S. Cl. CPC G06F 3/015; G06F 3/044; G06F 3/0416; G09B 5/02

(57) ABSTRACT

A control apparatus includes a picture providing unit configured to provide a picture for allowing a user to operate, and an operation detector configured to detect operation of the user performed on the picture. In addition, the control apparatus includes a biological information detector configured to detect biological information of the user that is different from the operation of the user, and a controller configured to change the picture depending on the biological information.

### BACKGROUND

1. Technical Field

The present disclosure relates to a control apparatus configured to detect operation of a user performed to a picture to control a picture display.

2. Description of the Related Art

A display apparatus including an input apparatus having a screen input function for inputting information by touch operation with a finger of a user and the like to a display screen, has been used for mobile electronic devices, such as a PDA (Personal Digital Assistant) and a mobile terminal, various consumer electronics products, and a stationary customer guidance terminal such as an unmanned reception machine. As a touch detection method in the input apparatus by such touch operation, a capacitive coupling method has been known for detecting a change in capacitance. For example, a touch panel apparatus has been known, such as PTL 1.

On the other hand, in recent years, with progress of an aging society, a demand for contribution to medical welfare has been increasing. For example, there is a demand for efforts to provide appropriate exercise.

### CITATION LIST

### Patent Literature

PTL 1: Unexamined Japanese Patent Publication No. 2012-160172

### SUMMARY

The present disclosure provides a picture that prompts a user to exercise appropriately by using a control apparatus configured to detect operation of the user performed to the picture, such as a touch panel apparatus.

A control apparatus of the present disclosure includes a picture providing unit configured to provide a picture for allowing the user to operate, and an operation detector configured to detect operation of the user performed on the picture. In addition, the control apparatus includes a biological information detector configured to detect biological information of the user that is different from the operation of the user, and a controller configured to change the picture depending on the biological information.

With the present disclosure, it is possible to provide the picture that prompts the user to exercise appropriately by using the control apparatus configured to detect the operation of the user performed to the picture, such as the touch panel apparatus.

### BRIEF DESCRIPTION OF DRAWINGS

FIG. 1 is a conceptual diagram illustrating a configuration of a display control system according to a first exemplary embodiment;

FIG. 2A is a conceptual diagram illustrating a GUI displayable range depending on physical information and the like of a user according to the first exemplary embodiment;

FIG. 2B is a conceptual diagram illustrating a GUI displayable range depending on physical information and the like of a user according to the first exemplary embodiment;

FIG. 2C is a conceptual diagram illustrating a GUI displayable range depending on physical information and the like of a user according to the first exemplary embodiment;

FIG. 3 is a flowchart illustrating operation of shape/speed changes of a GUI display and determination of a GUI displayable range of the display control system according to the first exemplary embodiment;

FIG. 4 is a flowchart illustrating operation of a question sentence display for performing diagnosis of a user in the display control system according to the first exemplary embodiment;

FIG. 5 is a flowchart illustrating operation of shape/speed changes of a GUI display and determination of a GUI displayable range of a display control system according to a second exemplary embodiment;

FIG. 6 is a flowchart illustrating operation of display control of a mark in a display control system according to a third exemplary embodiment;

FIG. 7A is a conceptual diagram of control of the mark in the display control system according to the third exemplary embodiment;

FIG. 7B is a conceptual diagram of the control of the mark in the display control system according to the third exemplary embodiment;

FIG. 7C is a conceptual diagram of the control of the mark in the display control system according to the third exemplary embodiment;

FIG. 8 is a conceptual diagram illustrating a configuration of a display control system according to another exemplary embodiment; and

FIG. 9 is a conceptual diagram illustrating operation of a display control system according to a modified example of another exemplary embodiment.

### DETAILED DESCRIPTION

Exemplary embodiments will be described in detail below with appropriate reference to drawings. However, an unnecessarily detailed description may be omitted. For example, a detailed description of an already well known matter and a duplicate description for substantially the same configuration may be omitted. This is to avoid the description below is unnecessarily redundant, and to facilitate understanding of those skilled in the art.

Incidentally, accompanying drawings and the description below are provided so that those skilled in the art sufficiently understand the present disclosure, and are not intended to limit the claimed subject matter.

In the description below, a picture includes a still image and a moving image.

### First Exemplary Embodiment

A first exemplary embodiment will be described below with reference to accompanying drawings.

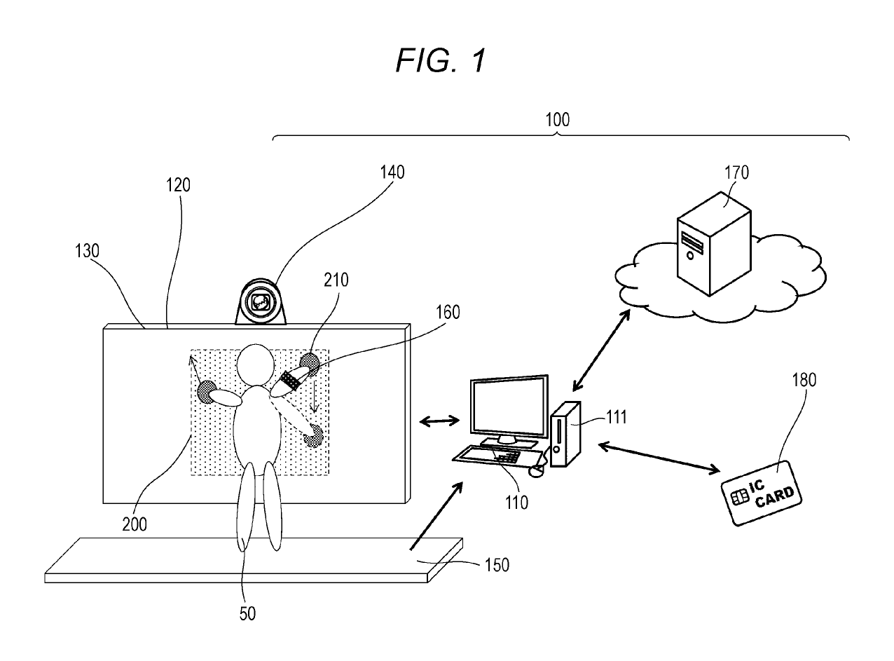

FIG. 1 is a conceptual diagram illustrating a configuration of display control system 100 according to the first exemplary embodiment. Display control system 100 includes personal computer 110 (hereinafter referred to as PC 110), display panel 120, capacitive sensor 130, camera 140, pressure sensor 150, and cloud server 170. PC 110 includes card reader 111 into which IC card 180 can be inserted, as a peripheral device. User 50 attaches biological sensor 160 to one's own arm and the like to utilize provision of exercise by display control system 100. Each configuration will be described below.

PC 110 is communicatively connected by wired or wireless manner with display panel 120, capacitive sensor 130, camera 140, pressure sensor 150, biological sensor 160, cloud server 170, and card reader 111. PC 110 is capable of acquiring various types of information from each of capacitive sensor 130, camera 140, pressure sensor 150, biological sensor 160, cloud server 170, and card reader 111. PC 110 determines displayable range 200 (hereinafter referred to as GUI displayable range 200) of a graphical user interface (hereinafter referred to as GUI) on display panel 120 based on the acquired various types of information. In addition, PC 110 is capable of displaying or hiding mark 210 at any position in determined GUI displayable range 200. In addition, PC 110 is capable of changing speed of displaying or hiding mark 210, and changing a shape and color of mark 210. Further, PC 110 is capable of displaying a picture including a text such as a question sentence and mark 210 on display panel 120.

Display panel 120 is capable of displaying the picture according to control by PC 110. It is preferable that display panel 120 is provided with a width wider than a width in which an average physique person spreads both arms. In addition, it is more preferable that display panel 120 is provided with a height equal to or higher than a height in which the average physique person extends both arms above one's head in a state of standing. Display panel 120 can be implemented by any display type such as a liquid crystal display type, and an organic EL (Electro Luminescence) display type.

Capacitive sensor 130 is disposed in front of a user 50 side of display panel 120 to detect touch operation by user 50 (motion of user). More specifically, capacitive sensor 130 detects position coordinates of the touch operation by user 50 by detecting a change in capacitance of a place touched by user 50. Capacitive sensor 130 transmits the position coordinates of the touch operation detected to PC 110. The position coordinates of the touch operation detected is utilized in PC 110 for correctness determination of a position to which the touch operation should be performed, and the like. In the present exemplary embodiment, capacitive sensor 130 is used as a touch panel.

Camera 140 is disposed in a periphery of display panel 120 (for example, a top) to image user 50. Camera 140 is, for example, an imaging apparatus equipped with an image sensor capable of RGB (Red Green Blue) color imaging. Camera 140 transmits image data generated by imaging user 50 to PC 110. The image data generated by camera 140 is utilized in PC 110 for detection of a standing position of user 50. Alternatively, the image data generated by camera 140 can be utilized in PC 110 for analysis of biological information (height, and the like) of user 50, authentication of a face of user 50, and the like.

Pressure sensor 150 is installed on a floor in front of display panel 120. User 50 stands on pressure sensor 150. It is preferable that pressure sensor 150 has an approximately the same width as a width of display panel 120. User 50 performs the touch operation to mark 210 displayed on display panel 120 in a state of being on pressure sensor 150. Pressure sensor 150 detects position coordinates of pressure based on weight of user 50 being on pressure sensor 150. Pressure sensor 150 transmits the position coordinates of the pressure detected to PC 110. The position coordinates of the pressure detected is utilized in PC 110 for detection of the standing position of user 50, and the like.

Biological sensor 160 is a wearable terminal to be attached to an arm or a head of user 50 oneself. Biological sensor 160 is one of sensors for acquiring the biological information, and detects a state of a living body, such as a pulse rate, respiratory rate, sweating, body temperature, and brain waves of user 50 to which biological sensor 160 is attached. Biological sensor 160 transmits the state of the living body detected to PC 110, such as the pulse rate, respiratory rate, sweating, body temperature, and brain waves. The state of the living body detected is utilized in PC 110 for a change of speed and a position of displaying mark 210 in GUI displayable range 200.

Cloud server 170 includes a database in which physical information and medical information of various users are managed with ID (Identification) and recorded. The physical information includes height, arm length, hand size, and weight of user 50. The medical information includes presence of injury or illness, a type of the injury or illness, a site of the injury or illness, and a test result of dementia diagnosis of user 50. Cloud server 170 searches the database based on ID information transmitted from PC 110, and returns corresponding information to PC 110.

IC card 180 is inserted into card reader 111 that is the peripheral device of PC 110. IC card 180 includes the ID information of user 50 who attempts to utilize display control system 100, such as a personal identification number, age, sex, address, name, and date of birth. The ID information included in IC card 180 is transmitted to PC 110 via card reader 111. The ID information included in IC card 180 is utilized for acquisition of the medical information from cloud server 170, as described above. Incidentally, without acquiring the physical information and medical information from cloud server 170, alternatively, the physical information and medical information can be recorded in advance in IC card 180. In addition, to allow PC 110 to work even when the ID information, physical information, medical information of user 50 are not registered in advance in cloud server 170, IC card 180, it may be configured to allow user 50 to directly input these pieces of information through operation to capacitive sensor 130 and PC 110.

With the above configuration, display control system 100 provides a picture that prompts user 50 to exercise appropriately. When providing the picture that prompts user 50 to exercise appropriately, display control system 100 determines GUI displayable range 200 depending on the physical information and the like of user 50.

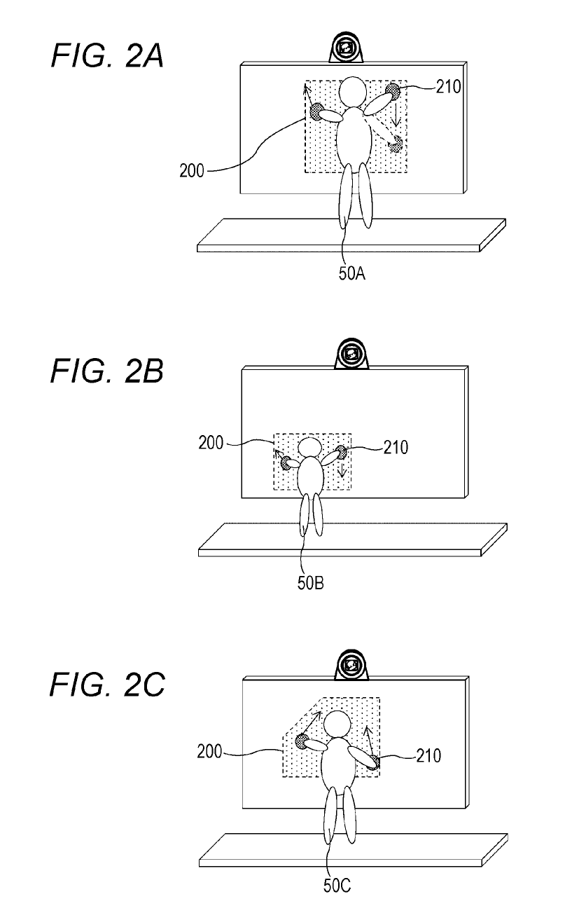

FIG. 2A is a conceptual diagram illustrating GUI displayable range 200A depending on the physical information and the like of user 50A according to the first exemplary embodiment. FIG. 2B is a conceptual diagram illustrating GUI displayable range 200B depending on the physical information and the like of user 50B according to the first exemplary embodiment. FIG. 2C is a conceptual diagram illustrating GUI displayable range 200C depending on the physical information and the like of user 50C according to the first exemplary embodiment. FIGS. 2A, 2B, and 2C respectively illustrate GUI displayable ranges 200A, 200B, 200C of when the physiques and the like of users 50A, 50B, 50C are different from each other. User 50A illustrates an adult of an average physique. User 50B illustrates a child of a smaller physique than the adult of the average physique. User 50C illustrates an adult of the average physique who is injured in the left arm.

As described later with reference to FIGS. 2A, 2B, and 2C, display control system 100 determines the GUI displayable range to fit a physique and the like of the user. As illustrated in FIG. 2A, display control system 100 determines GUI displayable range 200A to fit the physique of user 50A who is an adult, and displays mark 210 in GUI displayable range 200A determined. Similarly, as illustrated in FIG. 2B, display control system 100 determines GUI displayable range 200B to fit the physique of user 50B who is a child, and displays mark 210 in GUI displayable range 200B determined. As illustrated in FIG. 2C, display control system 100 determines GUI displayable range 200C to fit the physique of user 50C who is an adult and injured in the left arm while performing correction of decreasing a range of the left arm side. Display control system 100 displays mark 210 in GUI displayable range 200C determined.

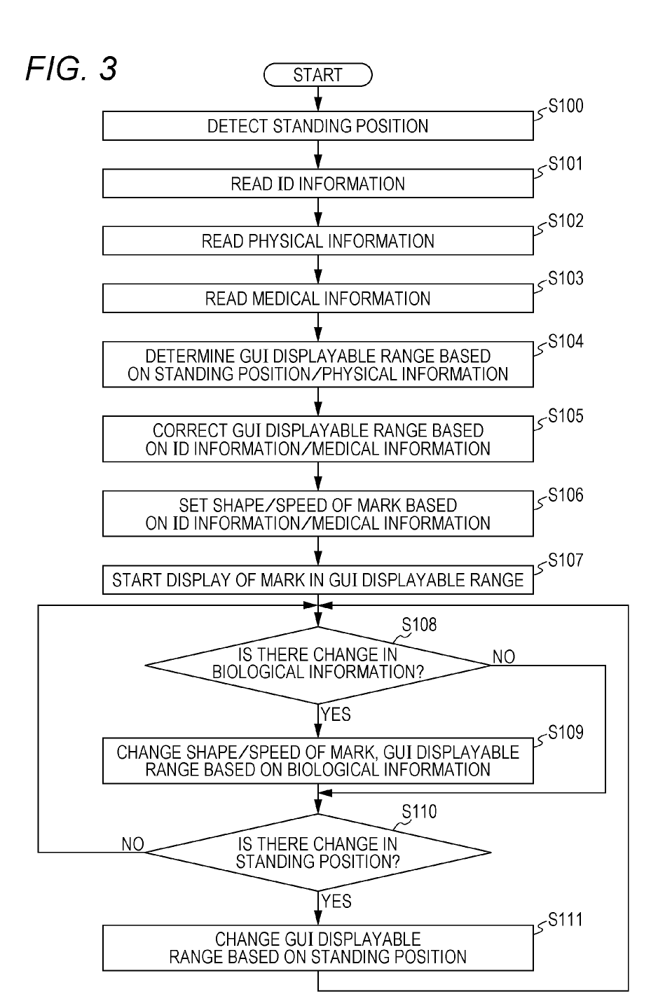

Operation will be described in detail below of display control system 100 configured as described above. FIG. 3 is a flowchart illustrating operation of shape/speed changes of a GUI display, and determination of a GUI displayable range of display control system 100 according to the first exemplary embodiment.

When a power supply is an ON state of each apparatus that forms display control system 100, PC 110 activates a program to start operation of display control.

First, PC 110 detects the standing position of user 50 based on the image data generated by camera 140 or the position coordinates detected by pressure sensor 150 (step S100). That is, PC 110 detects a position in which user 50 stands in a width direction in front of display panel 120.

PC 110 reads the ID information of user 50 from IC card 180 inserted into card reader 111 (step S101). PC 110 acquires the physical information, medical information corresponding to user 50 from cloud server 170 based on the ID information read from IC card 180 (step S102, S103).

PC 110 determines GUI displayable range 200 based on the standing position of user 50 detected in step S100 and the physical information (height, arm length, hand size, and the like) of user 50 acquired in step S102. Specifically, PC 110 determines the standing position of user 50 as a reference position in determining GUI displayable range 200. For example, PC 110 determines a center line of GUI displayable range 200 to come in front of the standing position of user 50. PC 110 determines length in a vertical direction of GUI displayable range 200 in a reasonable range for a person to exercise generally, based on the height, arm length, hand size of user 50. On the other hand, PC 110 determines length in a horizontal direction of GUI displayable range 200 in a reasonable range for user 50 to exercise, based on the arm length, hand size of user 50.

PC 110 corrects GUI displayable range 200 once determined in step S104 based on the ID information (age, sex, and the like) acquired in step S102 and the medical information (presence of injury or illness of user, type of injury or illness, site of injury or illness, test result of dementia diagnosis, and the like) acquired in step S103 (step S105). For example, when the age of the user is equal to or higher than a predetermined age (relatively senior), or less than a predetermined age (relatively juvenile), GUI displayable range 200 is corrected to be decreased. In addition, when the user is female, GUI displayable range 200 is corrected to be decreased. Alternatively, when the user is user 50 who is injured in the left arm, GUI displayable range 200 is corrected to be decreased in the left arm side.

PC 110 sets a display shape, a display speed, a display size, number of displays of mark 210 to be displayed in GUI displayable range 200 based on the ID information (age, sex, and the like) acquired in step S101 and the medical information acquired in step S103 (step S106). For example, a reference value is prepared for each of the display shape, the display speed, the display size, the number of displays, and then each of values is shifted from the reference value depending on whether the age is high or low, depending on the sex, or depending on presence of the injury.

After performing as described above, in GUI displayable range 200 that has been corrected in step S105, PC 110 starts a random display of mark 210 on conditions set in step S106 (step S107). User 50 starts the touch operation to mark 210 displayed in GUI displayable range 200. Mark 210 is hidden when a certain period of time elapses after being displayed. User 50 needs to complete the touch operation in a period during which mark 210 is displayed, so that the user is prompted to perform brain and body exercises moderately.

While mark 210 is displayed in GUI displayable range 200, PC 110 monitors whether or not there is a change in the biological information detected by biological sensor 160 (step S108). When there is no change that exceeds a predetermined value in the biological information monitored (step S108: No), PC 110 continues the random display of mark 210 in GUI displayable range 200 without changing GUI displayable range 200 determined in step S105 and the conditions set in step S106. On the other hand, when there is a change that exceeds the predetermined value in the biological information monitored (step S108: Yes), PC 110, depending on a degree of the change, corrects GUI displayable range 200 determined in step S105, and changes the conditions set in step S106 (step S109). Then, PC 110 continues the random display of mark 210 on conditions after the change to GUI displayable range 200 after the correction. For example, when there is a change that exceeds a predetermined value in a value indicating any of the pulse rate, respiratory rate, sweating, GUI displayable range 200 is corrected to be decreased. In addition, a burden to user 50 is reduced by making the display speed slow, decreasing the number of displays, enlarging the display shape of mark 210. Thus, it is possible to continue providing the picture that prompts user 50 to exercise moderately.

In addition, display control system 100 can display mark 210 simultaneously in a plurality of positions in GUI displayable range 200. Thus, it is possible to further provide the picture that prompts user 50 to exercise appropriately.

While mark 210 is displayed in GUI displayable range 200, PC 110 monitors the standing position of user 50 detected by camera 140 or pressure sensor 150 (step S110). When there is no change that exceeds a predetermined value in the standing position monitored (step S110: No), PC 110 returns to the operation of step S108 without correcting GUI displayable range 200. On the other hand, when there is a change that exceeds the predetermined value in the standing position monitored (step S110: Yes), PC 110 corrects GUI displayable range 200 depending on the standing position. For example, if the standing position of user 50 moves a distance of 30 cm to the left when viewed from user 50, PC 110 performs correction to move the reference position of GUI displayable range 200 the distance of 30 cm to the left when viewed from user 50. Thus, even when user 50 moves, it is possible to continue providing the picture that prompts user 50 to exercise.

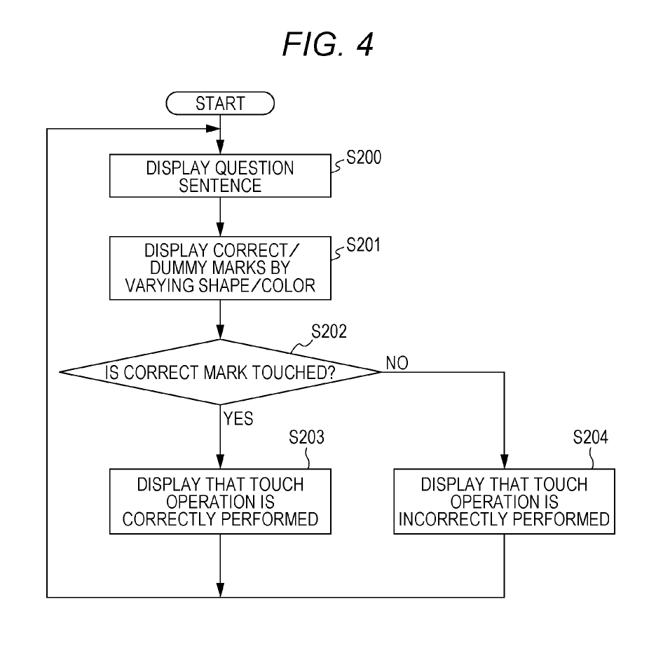

FIG. 4 is a flowchart illustrating operation of a question sentence display for performing diagnosis of user 50 in display control system 100 according to the first exemplary embodiment. Here, as one example of an operation method for displaying mark 210 in GUI displayable range 200, operation of a question sentence display is described.

PC 110, when starting the display in step S107 illustrated in FIG. 3, displays the question sentence on display panel 120 (step S200). For example, red round mark 210 is “correct,” and black square mark 210 is “incorrect (dummy).” At this time, on display panel 120, a question sentence is displayed for instructing the touch operation to red round mark 210. Then, PC 110 starts a display of correct and dummy marks 210 in GUI displayable range 200.

PC 110 monitors whether or not user 50 correctly performs the touch operation to correct mark 210 (step S202). When user 50 correctly performs the touch operation to correct mark 210 (step S202: Yes), PC 110 displays, on display panel 120, that the touch operation is correctly performed (step S203). On the other hand, when user 50 does not correctly perform the touch operation to correct mark 210 (when the touch operation is incorrectly performed to dummy mark 210, for example), PC 110 displays, on display panel 120, that the touch operation is incorrectly performed (step S204).

When a series of questions has been completed, a grade is displayed of a number of correct answers to the questions of user 50. PC 110 stores the grade of user 50 to an external recording medium.

When operation from user 50 is performed for stopping operation, or the question has been completed, PC 110 ends the program according to the above series of display operation. Then, PC 110 performs diagnosis of an amount of exercise, superiority or inferiority of a motor function, a degree of progress of dementia of user 50 based on accuracy of the touch operation to mark 210 correctly performed by user 50 (operation accuracy) and time required by user 50 from when the display of mark 210 is started to when the touch operation is performed (operation reaction time). Then, PC 110 displays a diagnosis result on display panel 120.

PC 110 stores the individual identification information, physical information, medical information acquired, and GUI displayable range 200, the conditions according to the display speed, the display size, the display shape, the number of displays of mark 210 that are determined based on these pieces of information, the diagnosis result, in the external recording medium.

As described above, a control apparatus corresponding to display control system 100 of the present exemplary embodiment includes a picture providing unit corresponding to display panel 120 configured to provide a picture for allowing user 50 to operate, and an operation detector corresponding to capacitive sensor 130 configured to detect operation of user 50 performed on the picture. In addition, the control apparatus includes a biological information detector corresponding to biological sensor 160 configured to detect the biological information of user 50 that is different from the operation of user 50, and a controller corresponding to PC 110 configured to change the picture depending on a change of the biological information.

Thus, it is possible to provide the picture that prompts user 50 to exercise appropriately by using the control apparatus configured to detect the operation of user 50 performed to the picture, such as a touch panel apparatus.

In addition, the controller, depending on the change of the biological information, can change at least one of the display position, the display speed, and the number of displays of the picture. Thus, it is possible to provide the picture that prompts user 50 to exercise appropriately.

In addition, the biological information can be a pulse rate or a heart rate. Thus, it is possible to provide the picture that prompts user 50 to exercise appropriately.

In addition, the operation detector can be a touch panel. Thus, it is possible to provide the picture that prompts user 50 to exercise appropriately.

### Second Exemplary Embodiment

Hereinafter, a second exemplary embodiment will be described with reference to accompanying drawings. For display control system 100 according to the second exemplary embodiment, the configuration is the same as that of the first exemplary embodiment described with reference to FIG. 1, so that a detailed description is omitted. Display control system 100 according to the second exemplary embodiment is different in a determination method of GUI displayable range 200 from that of the first exemplary embodiment.

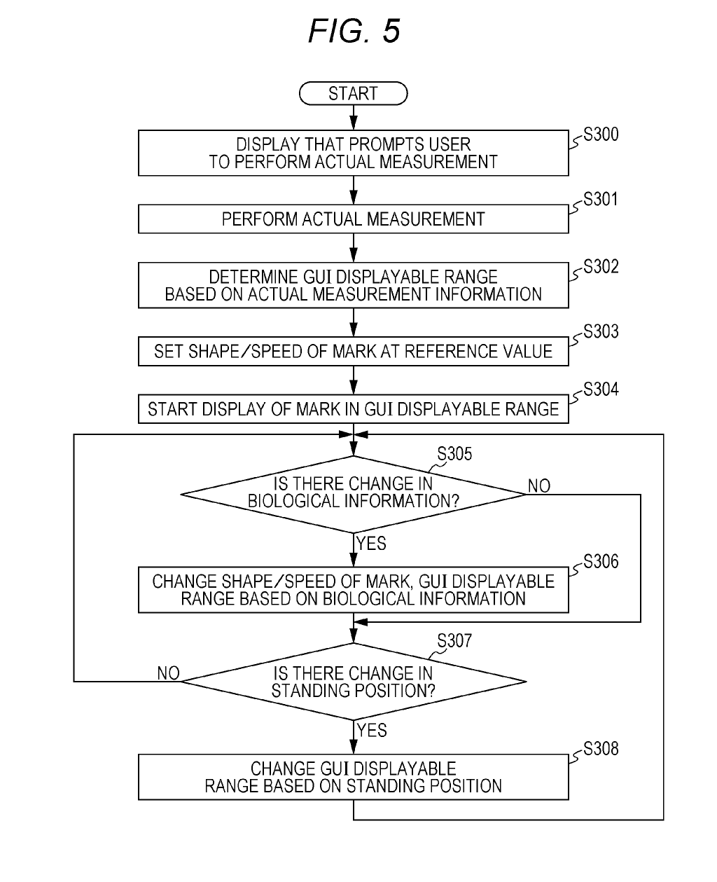

FIG. 5 is a flowchart illustrating operation of shape/speed changes of a GUI display, and determination of a GUI displayable range of display control system 100 according to the second exemplary embodiment.

First, PC 110 performs on display panel 120 a display that prompts user 50 to perform actual measurement (step S300). For example, PC 110 sequentially performs a display that instructs actual measurement of a top side of GUI displayable range 200, a display that instructs actual measurement of a right side, a display that instructs actual measurement of a left side, a display that instructs actual measurement of a bottom side. User 50 performs touch operation to capacitive sensor 130 for each instruction displayed on display panel 120. For example, when the display is performed that instructs the actual measurement of the left side of GUI displayable range 200, user 50 extends the left arm to a left direction as much as possible from a current standing position to perform the touch operation to capacitive sensor 130. Similarly, when the display is performed that instructs the actual measurement of the right side of GUI displayable range 200, user 50 extends the right arm to a right direction as much as possible from the current standing position to perform the touch operation to capacitive sensor 130. PC 110 actually measures position coordinates to which the touch operation by user 50 is performed, in association with each instruction (step S301). PC 110 performs the actual measurement for places that are required to determine GUI displayable range 200.

PC 110 determines GUI displayable range 200 based on actual measurement information obtained by the actual measurement in step S301 (step S302). PC 110 sets the display shape, the display speed, the display size, the number of displays of mark 210 at the reference value (step S303). After performing as described above, in GUI displayable range 200 determined in step S302, PC 110 starts a random display of mark 210 on the conditions set in step S303 (step S304). User 50 starts the touch operation to mark 210 displayed in GUI displayable range 200. Mark 210 is hidden when a certain period of time elapses after being displayed. User 50 needs to complete the touch operation in a period during which mark 210 is displayed, so that user 50 is prompted to perform the brain and body exercises moderately.

While mark 210 is displayed in GUI displayable range 200, PC 110 monitors biological information detected by biological sensor 160 (step S305). When there is a change in the biological information (step S305: Yes), PC 110, based on the biological information, changes the conditions set in step S303 depending on a degree of the change, and continues the random display of mark 210 in GUI displayable range 200 (step S306). Operation from step S305 to S308 is the same as that of from step S108 to S111 described with reference to FIG. 3.

As described above, display control system 100 is capable of determining GUI displayable range 200 by the actual measurement based on the touch operation of user 50.

### Third Exemplary Embodiment

Hereinafter, a third exemplary embodiment will be described with reference to the accompanying drawings. For display control system 100 according to the third exemplary embodiment, the configuration is the same as that of the first exemplary embodiment described with reference to FIG. 1, so that a detailed description is omitted. Display control system 100 according to the third exemplary embodiment is partially different in a control method of the display speed and the number of displays of mark 210 and determination of GUI displayable range 200 from those of the first exemplary embodiment.

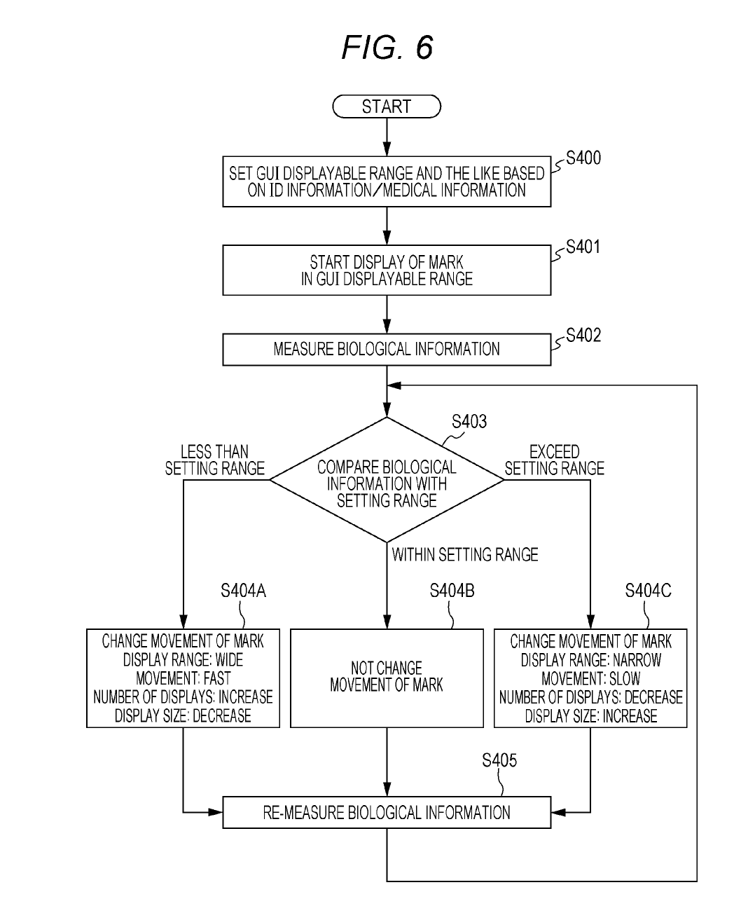

FIG. 6 is a flowchart illustrating operation of display control of mark 210 in display control system 100 according to the third exemplary embodiment.

First, PC 110, based on ID information such as age, sex, and medical information such as presence of injury or illness, or a test result of dementia diagnosis, determines GUI displayable range 200 that is a position in which mark 210 can be displayed, and determines a display pattern such as a display speed, a number of displays, a display size of mark 210 (step S400).

For example, in a case of a user whose age is equal to or higher than a predetermined age (senior) or who is recognized to have a mild cognitive impairment, or the like, PC 110 determines GUI displayable range 200 to be decreased, and determines the speed to be slowed, the number of displays to be decreased, and the display size to be increased of mark 210. In addition, in a case of a user whose ID information and medical information do not exist, PC 110 skips step S400, and substitutes standard values set in advance for the ID information and medical information.

Here, the display pattern is the one that changes according to a certain rule. In a case of a display pattern of mark 210, as described above, a display position, a display speed, a number of displays, a display size are determined. According to the rules determined, mark 210 moves in GUI displayable range 200.

According to the display pattern determined as described above, PC 110 starts a display of mark 210 (step S401).

User 50 performs touch operation to mark 210. As a result, user 50 moves a position of the finger or hand, that is, moves the body according to movement of mark 210. By controlling the movement of mark 210, display control system 100 is capable of controlling an amount of exercise of user 50.

While mark 210 is displayed, PC 110 monitors biological information detected by biological sensor 160 (step S402). PC 110 compares the biological information monitored and the biological information of a setting range with each other (step S403).

In step S403, when the biological information is less than the setting range, that is, less than a lower limit of the setting range, PC 110 changes the display pattern by selecting any one or a plurality of, widening a display range, making the movement fast, increasing the number of displays, decreasing the display size of mark 210, to the display pattern currently set (the display pattern set in step S400, in a case of immediately after the start) (step S404A).

In addition, when the biological information is within the setting range, PC 110 does not change the display pattern (movement of mark 210) currently set (step S404B).

In addition, when the biological information exceeds the setting range, that is, exceeds an upper limit of the setting range, PC 110 changes the display pattern by selecting any one or plurality of narrowing the display range, making the movement slow, decreasing the number of displays, increasing the display size of mark 210, to the display pattern currently set (the display pattern set in step S400, in a case of immediately after the start).

After changing the display pattern of mark 210, PC 110 re-measures the biological information (step S405) and compares the biological information re-measured with the setting range again to control the display of mark 210.

As described above, PC 110 changes the display pattern based on the biological information measured, that is, changes the display range, the display speed, the number of displays, or the display size of mark 210.

Here, the biological information will be described with reference to a specific example. The present exemplary embodiment is a case in which the biological information is the heart rate and an exercise load is continued in an aerobic exercise state. At this time, the setting range is a range for maintaining an aerobic state. For the aerobic exercise state, from the age and heart rate, it is known that the following relationship is established. The heart rate during aerobic exercise can be calculated by (220−age)×(60% to 70%). The heart rate calculated by the relationship is a standard heart rate during the aerobic exercise. Specifically, the standard heart rate during the aerobic exercise of a person of age 70 is a range from 90 beats/minute to 105 beats/minute. This range can be the setting range.

That is, for the person of age 70 to efficiently perform the aerobic exercise, in FIG. 6, the heart rate of the range from 90 beats/minute to 105 beats/minute (one example of setting range) should be maintained. That is, when the heart rate is less than 90 beats, PC 110 changes the movement of mark 210 to increase the amount of exercise, and when the heart rate exceeds 105 beats, PC 110 changes the movement of mark 210 to decrease the amount of exercise. Thus, it becomes possible to maintain an exercise state of user 50 in the aerobic exercise state.

Incidentally, although the aerobic exercise state has been described as one example, even in cases of high exercise strength and low exercise strength, it is possible to easily control the amount of exercise by changing the setting range similarly. In addition, other than the heart rate, it is possible to control the movement of mark 210 by using a respiratory rate, sweating, body temperature, brain waves as the biological information as mentioned above.

As described above, display control system 100 is capable of controlling the movement of mark 210 depending on the biological information based on the touch operation of the user. Thus, it becomes possible to control the amount of exercise of the user.

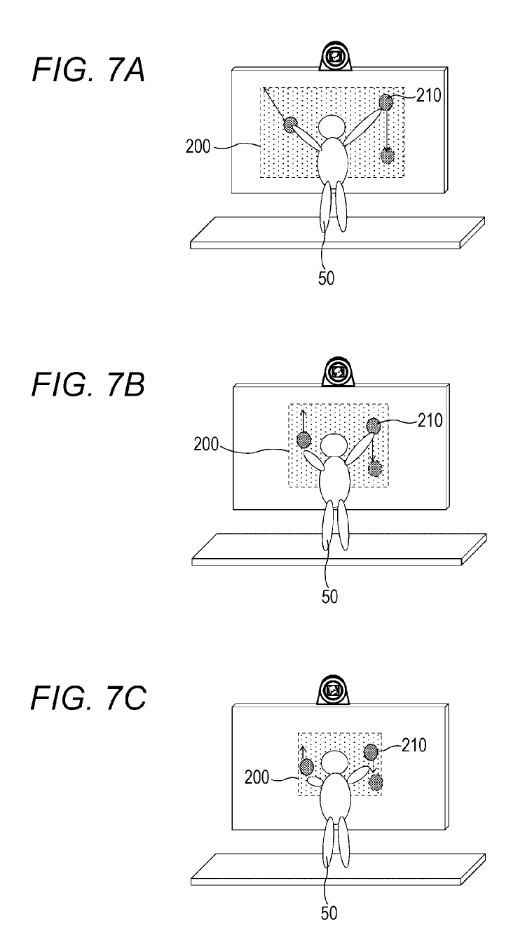

The control of mark 210 mentioned above will be described with reference to FIGS. 7A, 7B, 7C. FIG. 7A is a conceptual diagram of the control of mark 210 in display control system 100 according to the third exemplary embodiment. FIG. 7B is a conceptual diagram of the control of mark 210 in display control system 100 according to the third exemplary embodiment. FIG. 7C is a conceptual diagram of the control of mark 210 in display control system 100 according to the third exemplary embodiment. In FIGS. 7A, 7B, 7C, speed of the movement of mark 210 is indicated by length of an arrow in the figures. Incidentally, GUI displayable range 200 set in step S400 of FIG. 6 is the one illustrated in FIG. 7B. When the biological information is less than the setting range, PC 110 changes the display of mark 210 by selecting any one or plurality of widening the display range, making the movement fast, increasing the number of displays, decreasing the display size of mark 210, to the range set in step S400 (FIG. 7A).

On the other hand, when the biological information exceeds the setting range, PC 110 changes the display of mark 210 by selecting any one or plurality of narrowing the display range, making the movement slow, decreasing the number of displays, increasing the display size of mark 210 (FIG. 7C).

In addition, when the biological information is within the setting range, PC 110 does not change the display range, movement of mark 210 from the ones set in step S400 (FIG. 7B).

Incidentally, for the display pattern of mark 210, another display pattern is also considered other than the pattern that allows the user to exercise by moving mark 210 in GUI displayable range 200 and allowing the user to follow mark 210 with the finger, hand, or the like, as mentioned above.

For example, it can be a display pattern in which mark 210 is hidden when a certain period of time elapses after being displayed and then mark 210 is displayed at another position. The user can exercise by performing the touch operation to mark 210 that blinks while changing the position. In this case, the speed of mark 210 can be changed depending on the display period (blinking interval), the display position of a next mark, or the like.

In addition, for the touch operation, depending on the user, there is a case in which the user cannot perform the touch operation, such as a case in which the user cannot follow the movement of mark 210 and touches a different position from mark 210. In this case, PC 110 can change the GUI displayable range, the display speed, the number of displays, the display size determined in step S400 so that the touch operation becomes easy. Specifically, PC 110 can narrow the display range, make the display speed slow, decrease the number of displays, increase the display size.

For example, when user 50 does not perform the touch operation, PC 110 can display, on display panel 120, a sentence that prompts user 50 to perform the touch operation, and generate a voice or make a sound that prompts user 50 to perform the touch operation.

In addition, by combining the case in which the touch operation cannot be performed and the biological information, it is possible to allow the user to efficiently exercise. For example, when the user cannot perform the touch operation and the heart rate of the user (biological information) is within a predetermined range, PC 110 does not change the movement of mark 210. When the user cannot perform the touch operation and the heart rate of the user (biological information) exceeds the predetermined range, PC 100 can make a degree greater of decreasing the display range, making the display speed slow, decreasing the number of displays, or increasing the display size of mark 210, than a case of determining by only the heart rate.

As described above, a controller corresponding to PC 110 of the present exemplary embodiment changes a picture when the biological information is outside the predetermined range. Thus, it is possible to provide the picture that prompts user 50 to exercise appropriately.

In addition, the controller does not change the picture when the biological information is within the predetermined range, and performs at least one of widening the display range of the picture, making the movement of the picture fast, increasing the number of displays of the picture, decreasing the display size of the picture when the biological information is less than the predetermined range. In addition, the controller performs at least one of narrowing the display range of the picture, making the movement of the picture slow, decreasing the number of displays of the picture, increasing the display size of the picture when the biological information exceeds the predetermined range. Thus, it is possible to provide the picture that prompts user 50 to exercise appropriately.

### Other Exemplary Embodiment

As described above, the first to third exemplary embodiments have been described as illustrations of the technique disclosed in the present application. However, the technique of the present disclosure is not limited thereto, and it is also possible to apply to an exemplary embodiment in which modification, replacement, addition, omission are appropriately performed. In addition, it is possible to make a new exemplary embodiment by combining elements described in the above first to third exemplary embodiments.

In the above first to third exemplary embodiments, display control system 100 determines GUI displayable range 200, and displays mark 210 in GUI displayable range 200 determined. It means that a range for displaying mark 210 that prompts user 50 to exercise is inside GUI displayable range 200. Therefore, whether or not an icon that is fixedly displayed (selection icon of operation mode of display control system 100, and the like) is displayed outside GUI displayable range 200, it is a scope of a technical idea of the present disclosure.

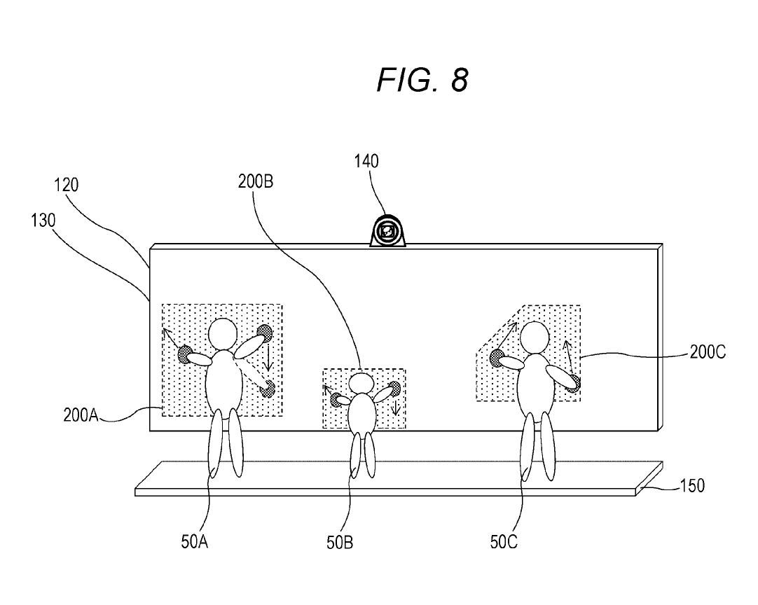

In the first to third exemplary embodiments, although display control system 100 has been exemplified that includes each one of display panel 120, capacitive sensor 130, camera 140, pressure sensor 150 for one user 50, the present disclosure is not limited thereto. FIG. 8 is a conceptual diagram illustrating a configuration of display control system 100 according to another exemplary embodiment. As illustrated in FIG. 8, each one of display panel 120, capacitive sensor 130, camera 140, pressure sensor 150 can be included in display control system 100 for a plurality of users 50A, 50B, 50C. Even in that case, as illustrated in FIG. 8, display control system 100 respectively determines GUI displayable ranges 200A, 200B, 200C to fit physiques and the like of the plurality of users 50A, 50B, 50C, and displays mark 210 in GUI displayable ranges 200A, 200B, 200C determined.

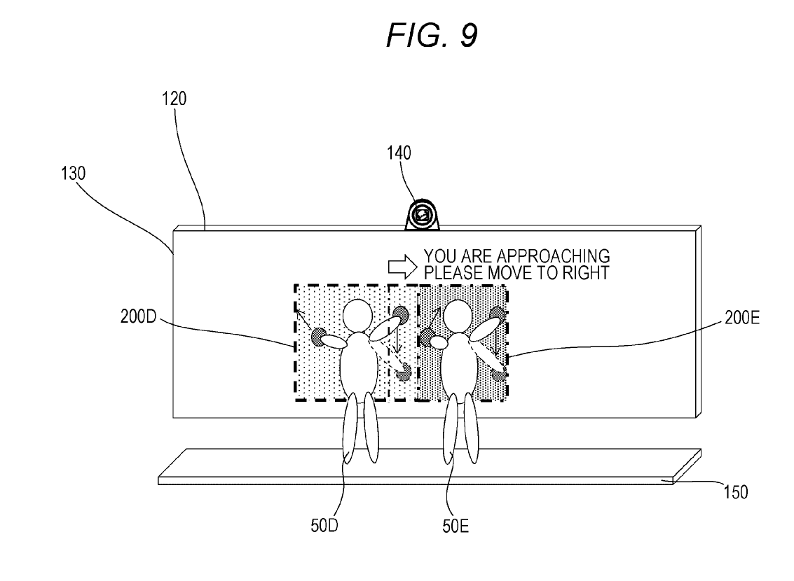

In addition, as illustrated in FIG. 8, when the plurality of users utilizes display control system 100, depending on each of the users, order (priority) can be set that prioritizes the users for the GUI displayable range. FIG. 9 is a conceptual diagram illustrating operation of display control system 100 according to a modified example of another exemplary embodiment. In the modified example illustrated in FIG. 9, the priority of user 50D is set higher than the priority of user 50E. A case is considered in which both of GUI displayable ranges 200D, 200E become close enough to be overlapped with each other due to the movement of user 50D or user 50E. Display control system 100 corrects GUI displayable range 200E of user 50E whose priority is low to limit (decrease) the range so that the range does not overlap with GUI displayable range 200D of user 50D whose priority is high. Then, display panel 120 can give user 50E a warning of instructing to move away to a position that is visible from user 50D, such as “You are approaching. Please move to the right.” Incidentally, this warning can be a warning by sound from a speaker instead of the warning by a picture of display panel 120.

In the first to third exemplary embodiments, although display panel 120 has been exemplified as one example of a picture providing unit of the present disclosure, the present disclosure is not limited thereto. The picture providing unit can be a screen on which a picture is projected by a projector instead of display panel 120. In this case, the touch operation by the user to the picture projected on the screen can be detected by using a TOF (Time Of Flight) sensor and the like instead of capacitive sensor 130 exemplified as one example of the operation detector. Incidentally, the screen can be a commercially available screen material, and can be a wall surface or a desk surface.

In the first to third exemplary embodiments, although camera 140 has been exemplified as one example of the position detector of the present disclosure, the present disclosure is not limited thereto. As the position detector, pressure sensor 150, capacitive sensor 130, or an infrared sensor provided in a periphery of display panel 120 can be used.

In the first to third exemplary embodiments, although the example has been described of reading data recorded in IC card 180 by card reader 111, the present disclosure is not limited thereto. An RFID (Radio Frequency IDentifer) readable medium can be used. In addition, as a medium of this case, a mobile terminal capable of reading the RFID can be used.

The present disclosure can be applied to an application of detecting operation of a user performed to a picture, in a control apparatus configured to provide the picture. For example, in medical welfare such as senior support, or in an amusement such as a game, it is possible to provide the picture that prompts the user to exercise appropriately.

What is claimed is:

1. A control apparatus comprising:
a picture providing unit configured to provide a picture for allowing a user to operate;
an operation detector configured to detect operation of the user performed on the picture;
a biological information detector configured to detect biological information of the user that is different from the operation of the user;
a controller configured to change the picture depending on a change of the biological information.

2. The control apparatus according to claim 1, wherein
the controller changes at least one of a display position, a display speed, and a number of displays of the picture, depending on the change of the biological information.

3. The control apparatus according to claim 1, wherein
the controller changes the picture when the biological information is outside a predetermined range.

4. The control apparatus according to claim 1, wherein
the biological information is a pulse rate or a heart rate.

5. The control apparatus according to claim 1, wherein
the operation detector is a touch panel.

6. The control apparatus according to claim 1, wherein
the controller
does not change the picture when the biological information is within a predetermined range,
performs at least one of widening a display range of the picture, making a movement of the picture fast, increasing a number of displays of the picture, and decreasing a display size of the picture when the biological information is less than the predetermined range, and
performs at least one of narrowing the display range of the picture, making the movement of the picture slow, decreasing the number of displays of the picture, and increasing the display size of the picture when the biological information exceeds the predetermined range.
